(19) United States
(12) Patent Application Publication
(10) Pub. No.: US 2021/0205803 A1
(43) Pub. Date: Jul. 8, 2021

(54) FUNCTIONAL POROUS PARTICLES EMBEDDED/IMMOBILIZED WITHIN POROUS STRUCTURES, FORMATION & USES THEREOF

(71) Applicant: Metalmark Innovations, Inc, Boston, MA (US)

(72) Inventors: Elijah SHIRMAN, Arlington, MA (US); Tanya SHIRMAN, Arlington, MA (US)

(21) Appl. No.: 17/142,916

(22) Filed: Jan. 6, 2021

Related U.S. Application Data
(60) Provisional application No. 62/957,572, filed on Jan. 6, 2020.

(51) Int. Cl. B01J 37/00; B01J 20/26; B01J 20/08; B01J 20/02; B01J 20/28; B01J 20/30; B01J 31/06; B01J 21/04; B01J 23/72; B01J 23/44; B01J 35/02; B01J 35/04

(52) U.S. Cl. CPC B01J 37/0072; B01J 20/261; B01J 20/08; B01J 20/0237; B01J 20/0225; B01J 20/28016; B01J 35/04; B01J 20/3007; B01J 31/06; B01J 21/04; B01J 23/72; B01J 23/44; B01J 35/026; B01J 20/28042

(57) ABSTRACT

In one aspect, a composite porous composition is disclosed, which comprises a porous structure including a plurality of pores, and a plurality of functional particles distributed within at least some of said pores of the porous structure, wherein the particles comprise porous particles.

### RELATED APPLICATION

The present application claims priority to a Provisional Patent Application No. 62/957,572 titled “FUNCTIONAL POROUS PARTICLES EMBEDDED/IMMOBILIZED WITHIN POROUS STRUCTURES, FORMATION & USES THEREOF,” filed on Jan. 6, 2020, which is herein incorporated by reference in its entirety.

### BACKGROUND

The present teachings are generally directed to the design of composite porous materials and methods for their fabrication. Materials that contain pores ranging in size from sub-nanometer to millimeter are integral to various gas or liquid phase processes including purification, sorption, separation, energy conversion and storage, catalysis, sensing, drug delivery, tissue engineering, construction, and additive manufacturing. The design of complex porous functional materials is of high industrial importance, however, the realization of practical systems achieving simultaneous control over their composition and geometry on multiple length scales remains challenging.

### SUMMARY

In one aspect, the present teachings relate to functional porous particles (FPPs), e.g. powders fabricated through colloidal or polymer templating, that present many advantages in terms of controllability over their porosity (from sub-nm to mm), the choice of matrix materials (e.g., metal oxides, polymers, natural materials, mixtures thereof, etc.) and through incorporation of additional functional components (FCs, e.g., metallic, inorganic, organic, or biological components/nanoparticles) in the FPPs.

According to one aspect of the present teachings, prefabricated FPPs can be incorporated within a macroscopic porous structure (MPS) to form a composite porous material CPM (composite porous material). In some embodiments, the CPM is permeable to a variety of gases and liquids (pure and mixtures, such as air, N₂, O₂, H₂, Ar, CO₂, CO, NO, NO₂, SO₂ and other sulfur derivatives, and aqueous, organic, and inorganic compounds in gaseous and liquid forms). In such embodiments, the permeability of the CPM can enable the chemical functionality of the embedded FPPs, through interaction of the FPPs with gases or liquids flowing through the pores of the CPM.

In other embodiments, the CPM is not permeable to at least certain gases and liquids. Such CPMs can be designed to support such functionalities as structural, mechanical, or physical properties (e.g., based on interaction or production of sound, light or other forms of electromagnetic energy, etc.). For example, the CPM can be formed or treated to be hydrophilic or hydrophobic, either in full or in parts to allow or inhibit the introduction of water-based liquids into its pores relative to at least certain organic liquids into the pores. Surface modification approaches rendering the CPM hydrophobic or hydrophilic can include, but are not limited to, silanization, electrostatic deposition, atomic layer deposition, plasma treatment, liquid impregnation, layer-by-layer deposition, etc.) In some embodiments, the sizes and/or the affinity of the pores can be selected to reduce the permeability of the CPM to certain gases relative to other gases, for example utilizing size exclusion materials (e.g., metal organic frameworks (MOFs), or zeolites) or selective sorbents (e.g., amine-based) to form the CPM.

Some examples of the materials and particle types that can be used to form FPPs in accordance with the present teachings, which can be employed in both types of embodiments, that is, the embodiments in which the CPM is permeable to certain gases and/or liquids and those in which the CPM is not permeable to certain gases and/or liquids, can be found in: “Modular Design of Advanced Catalytic Materials Using Hybrid Organic-Inorganic Raspberry Particles”, which is herein incorporated by reference in its entirety, particularly its Section 6.

In some embodiments, the modularity of the compositions of matter disclosed herein enables the incorporation of multiple types of FPPs into a CPM, thus allowing rational design of complex catalytic or other functional systems. According to some embodiments, a CPM can be fabricated through incorporation or entrapment of FPPs during the process of formation of MPS. In some embodiments, the process can include sol-gel, polymerization, cross-linkage, light-induced polymerization, thermal polymerization, radical polymerization, supramolecular polymerization, other curing processes, and combinations thereof. According to other embodiments, a CPM can be fabricated through incorporation or entrapment of FPPs via post modification of a preformed MPS. In some embodiments, pore forming additives or blowing agents, such as hydrofluorocarbons, isocyanate, azodicarbonamide, sodium bicarbonate, titanium hydride, zirconium hydride, other metal hydrides, hydrazine, or carbon dioxide can be used to facilitate and direct the incorporation of FPPs into the CPM. The additives can be present in a mixture outside or within the FPPs.

The CPM compositions disclosed herein can find a variety of different uses. By way of example, in some embodiments, the composition of matter and the methods described herein relate to fabrication of CPMs that are capable of catalyzing one or more reactions, such as partial or complete oxidation, reduction, hydrogenation, dehydrogenation, hydration, dehydration, isomerization, oxidative coupling, dehydrogenative coupling, hydrosilylation, amination, hydroamination, C-H activation, insertion reactions, decomposition, and polymerization/depolymerization.

In some embodiments, the composition of matter and the methods described herein relate to fabrication of CPMs exhibiting selective catalytic activity towards formation of specific products or toward specific functional group(s) when different functions are present in the substrate molecule(s).

In some embodiments, the composition of matter and the methods described herein relate to fabrication of CPMs exhibiting sorption (both adsorption and absorption) properties including sorption of gases (e.g., volatile organic compounds, CO₂, CO, ammonia and its derivatives), particulate matter and microorganisms (e.g., bacteria, viruses etc.)

In some embodiments, the composition of matter and the methods described herein relate to fabrication of CPMs exhibiting both sorption and catalytic activity.

In some embodiments, the composition of matter and the methods described herein relate to the enabling of multiple catalytic functions within the same CPM through, e.g., the incorporation of different FPPs within the same CPM. Such CPMs can be formed, for example, by using a mixture of two or more FPPs during the fabrication process. The spatial separation between the different FPPs can then provide chemically distinct environments allowing simultaneous activation of different chemical processes and cascades or multistep catalytic reactions. By way of example, in some such embodiments, the incorporation of different FPPs in different spatial regions of the same CPM can provide a spatial and temporal compartmentalization of different local functionalities of the CPM. For example, oxidation and reduction reactions (separately or concurrently initiated by, e.g., light or heat), can take place simultaneously, or at different times, within the same CPM in which some of the FPPs facilitate oxidation reactions while other FPPs facilitate reduction reactions.

In some embodiments, the compositions of matter and the methods described herein relate to the incorporation of multiple catalytic functions within the same FPP, for example, via the incorporation of different functional units within the same FPP. The incorporation of such multi-functional FPPs into a CPM allows the respective CPM to provide multiple functions. For example, in some embodiments, a plurality of spatially separated pores can be functionalized such that certain pores of the FPP will provide one functionality and certain other pores will provide a different functionality, though more than two functionalities can also be incorporated in the same FPP. Such spatially separated pores bearing different functionalities can then enable simultaneous activation of different chemical processes, cascades or multistep catalytic reactions. For example, oxidation and reduction reactions (e.g., initiated by light or heat), can take place simultaneously within the same CPM while the different pores within the same FPP will provide a spatial and temporal compartmentalization with locally optimized reaction conditions. By way of example, such FPPs can be formed by using a mixture of two or more different FCs during the fabrication process, such as the fabrication processes disclosed herein.

In some embodiments, the compositions of matter and the methods described herein relate to fabrication of CPMs exhibiting multiple functions including sorption, separation, energy conversion/storage, catalysis, sensing, drug delivery, optics, mechanics, and acoustics.

In some embodiments, the compositions of matter and the methods described herein relate to fabrication of CPMs used in interior and/or exterior building materials, in-cabin and exterior materials of vehicles, airplanes, trains, buses, ships, space and other vehicles. Uses of such CPMs can include air purification, aesthetics, acoustic dampening/filtration/focusing, thermal insulation/dissipation/localization, electromagnetic filtration/dissipation/focusing, modification of mechanical properties (e.g., providing reinforcement, centers for stress dissipation, softening, enhancement or reduction of brittleness, etc.), and modification for chemical or biological applications (e.g., for tissue engineering or antimicrobial properties).

In some embodiments, the compositions of matter and the methods described herein relate to fabrication of CPMs exhibiting electrocatalytic activity.

In one aspect, a CPM composition is disclosed, which comprises an MPS including a plurality of pores, and a plurality of FPPs distributed within at least some of said pores of the MPS.

In a related aspect, the disclosed CPM composition can comprise a porous matrix including a plurality of pores, and a plurality of FPPs embedded, partially or fully, within microstructural elements of the porous matrix (e.g., walls). In yet another aspect, the plurality of FPPs are not fixedly embedded within some of the pores of the MPS but rather are trapped within at least some of the pores. Such FPPs are free to move within the pores of the MPS, although they cannot escape due to physical barriers such as narrow channels (smaller than the FPP size) connecting adjacent pores of the MPS. In yet another aspect, multiple FPPs can be present in some of the said pores, where the FPPs can be of the same or different type or functionality.

In some embodiments, the pores of an MPS can have pore sizes in a range of about 100 nm to about 5 mm, e.g., in a range of about 400 nm to about 3 mm, or in a range of about 600 nm to about 1 mm, or in a range of about 800 nm to about 0.8 mm, or in a range of about 1000 nm to about 500 microns, or in a range of about 2000 nm to about 200 microns, or in a range of about 2500 nm to 100 microns. In the context of this disclosure, the average pore size refers to, e.g., the pore diameter or another cross sectional dimension (e.g., the largest or the average cross-sectional dimension), e.g., in the case of a high aspect ratio pore (when the ratio between the long and the short dimension of a pore is greater than 1.5).

In some such embodiments, the FPPs can have sizes in the range of about 50 nm to 2 mm, e.g., in a range of about 200 nm to about 1 mm, or in a range of about 600 nm to about 0.5 mm, or in a range of about 1000 nm to about 200 microns, or in a range of about 2000 nm to about 100 microns, or in a range of about 5000 nm to about 50 microns.

In some such embodiments, each of the FPPs comprises a plurality of pores having sizes in a range of about 0.5 nm to about 100 microns, e.g., in a range of about 1 nm to about 50 microns, or in a range of 10 nm to about 20 microns, or in a range of about 2 nm to about 10 microns, or in a range of about 10 nm to about 5 microns, or in a range of about 20 nm to about 2.5 microns, or in a range of about 50 nm to about 2 microns.

In some embodiments, a plurality of functional components (FCs) is deposited in at least a portion of the pores of the FPPs. By way of example, such components can have a size in a range of atom size to about 500 nm, e.g., in a range of about 0.05 nm to about 200 nm or in a range of about 0.5 nm to about 100 nm, or in a range of about 1 nm to about 70 nm, or in a range of about 1.5 nm to about 60 nm, or in a range of about 2 nm to about 50 nm, or in a range of about 2.5 nm to about 40 nm, or in a range of about 3 nm to about 30 nm.

In some embodiments, the FCs (e.g., particles) deposited in the FPPs can comprise one or more metals. For example, the FCs can be in the form of metallic particles.

In some embodiments, the MPS comprises a plurality of discrete structures and/or particles arranged relative to one another to form the porous structure. In some embodiments, the porous structure comprises a single unitary structure.

In some embodiments, the MPS comprises an inorganic material. Some examples of suitable inorganic materials include metal oxides and mixed metal oxides such as silica, alumina, titania, ceria, zirconia, and hafnia. In some embodiments, the MPS comprises a polymeric material. Some examples of suitable polymeric materials include, without limitation, polyurethane, polystyrene, polyethylene, poly(vinylalcohol) and polyacrylate. In some embodiments, the FPPs can include inorganic, organic, polymeric, metallic, organometallic, biological or other types of materials. In some embodiments, the FC can comprise metallic, inorganic, organic, or biological components/nanoparticles.

### MATERIALS

### Macroscopic Porous Structure (MPS):

As noted above, in some embodiments, the MPS comprises a porous matrix incorporating the FPPs, e.g., via cross-linkage, sintering, or polymerization to form a CPM.

In certain embodiments, an MPS according to the present teachings can be fabricated from a ceramic material, such as cordierite, Mullite, zeolite, and natural or synthetic clay.

In certain embodiments, an MPS can be made from a metal salt or oxide, such as silica, alumina, alumina silicates, aluminum titanate, iron oxide, zinc oxide, tin oxide, beryllia, platinum group metal oxide, titania, zirconia, hafnia, molybdenum oxide, tungsten oxide, rhenium oxide, tantalum oxide, niobium oxide, vanadium oxide, chromium oxide, scandium oxide, yttria, lanthanum oxide, ceria, thorium oxide, uranium oxide, other rare earth oxides, and combinations thereof.

In certain embodiments, an MPS can be made from one or more metals and/or metal alloys, such as stainless steel, ferritic steel (e.g., an iron-chromium alloy), austenitic steel (a chromium-nickel alloy), copper, nickel, brass, gold, silver, titanium, tungsten, aluminum, palladium, platinum, and combinations thereof.

In certain embodiments, an MPS can be made from a polymer, such as polyurethane, polystyrene, poly(methyl methacrylate), polyacrylate, poly(alkyl acrylate), substituted polyalkylacrylate, polystyrene, poly(divinylbenzene), polyvinylpyrrolidone, poly(vinylalcohol), polyacrylamide, poly(ethylene oxide), polyvinyl chloride, polyvinylidene fluoride, polytetrafluoroethylene, other halogenated polymers, hydrogels, organogels, and combinations thereof. Other polymers of different architectures can be utilized as well, such as random and block copolymers, branched, star and dendritic polymers, and supramolecular polymers.

In certain embodiments, an MPS can be made from one or more natural materials, such as cellulose, natural rubber (e.g., latex), wool, cotton, silk, linen, hemp, flax, and feather fiber.

In certain embodiments, the MPS includes adjoint particulates. The particulates can be of arbitrary shape (e.g., spheroid, star-like, and elongated).

In certain embodiments, an MPS can be made from natural or synthetic fabrics and textiles, and combinations thereof.

### Functional Porous Particle (FPPs)

In certain embodiments, an FPP according to the present teachings can be made from a variety of materials or mixtures of materials. By way of example, in certain embodiments, the materials include one or more metals (such as gold, palladium, platinum, silver, copper, rhodium, ruthenium, rhenium, titanium, osmium, iridium, iron, cobalt, or nickel, or a combination thereof), semiconductors, oxides, mixed oxides, oxometalates, (such as silica, alumina, aluminosilicates, zeolites, titania, tin oxide, zirconia, iron oxide, hafnia, magnesium oxide, manganese oxide, molybdenum oxide, tungsten oxide, rhenium oxide, vanadium oxide, tantalum oxide, niobium oxide, chromium oxide, beryllia, platinum group metal oxides, scandium oxide, yttria, lanthanum oxide, ceria, thorium oxide, uranium oxide, other rare earth oxides, or a combination thereof), organometallic compounds (such as metal organic frameworks, inorganic polymers (such as silicone), organometallic complexes, or combinations thereof), covalent, non-covalent and supramolecular polymers (such as polystyrene, polyurethane, hydrogels, and organogels), natural materials (such as a protein- or polysaccharide-based material, silk fibroin, chitin, shellac, cellulose, chitosan, alginate, gelatin, or a mixture thereof.) and mixtures thereof.

In some embodiments, the FPP can be designed, for example, to be catalytically active, stimuli-responsive, chemically robust, degradable, and/or exhibit specific optical, thermal, mechanical, sorption, release, and/or acoustic properties. By way of example, the functional components can include catalytically active materials, for example, palladium, platinum, and metal oxide. For example, in some embodiments, the functional components can be in the form of metal nanoparticles, e.g., with sizes in a range of about 10 nm to about 1 micron, though other sizes can also be employed. In some embodiments, the functional components can be responsive to certain stimuli, e.g., light, heat, ultrasound, etc. For example, plasmonic nanoparticles can be responsive to certain wavelengths of the electromagnetic radiation (e.g., gold nanoparticles absorb strongly at ˜530 nm).

In some embodiments, the functional components can be responsive to heat. For example, the functional components can be formed of heat-responsive polymers, such as hydrogel. In yet other embodiments, the functional components can be responsive to magnetic fields. By way of example, in some such embodiments, the functional components can be formed of ferromagnetic materials, such as iron and/or iron oxide. In other embodiments, the functional components can be hydrophobic or hydrophilic (e.g., fluorinated or hydroxylated, respectively). In some embodiments, the functional components can be insoluble in water or corrosion resistant.

In certain embodiments, an FPP can be made in the form of a compound microparticle, i.e., with the pores filled (partially or completely) by a templating/functionalizing agent or by a temporary filler that is removed (partially or completely) at the end of the CPM fabrication process.

### Surface Modification of MPSs and FPPs

In certain embodiments, in order to improve the incorporation of the FPPs in the 3D architecture of CPMs (e.g., homogeneity, mechanical integrity, preservation of porosity, and/or dispersion stability) the surface of MPS and/or of the CPM precursor and/or FPP can be modified. By way of example, the modification can be performed, e.g., through heat treatment, control of pH, or chemically.

### Functional Components

In some embodiments, the compositions of matter and the methods described herein relate to the incorporation of FPPs possessing highly porous structures with interconnected porosity, as well as decorated with FCs into an MPS. The FCs can be further designed to provide catalytic, photocatalytic, electrocatalytic, photonic, antimicrobial, light absorbing and/or emitting, stimuli responsiveness, adsorption, and desorption properties. The FCs can be introduced into the FPPs, for example, prior to or during the fabrication of CPM or through its post modification.

By way of example, the FCs can include metal nanoparticles, (such as gold, silver, platinum, palladium, ruthenium, rhodium, cobalt, iron, nickel, osmium, iridium, rhenium, copper, chromium, tungsten, molybdenum, vanadium, niobium, tantalum, titanium, zirconium, hafnium, bimetals, metal alloys, metal compounds, such as pnictides, hydroxides, binary and complex salts, including heteropolyacids and their derivatives or a combination thereof), metal oxides and metal sulfide (such as vanadia, silica, alumina, noble metal oxides, platinum group metal oxides, titania, zirconia, hafnia, molybdenum oxides, tungsten oxides, rhenium oxides, tantalum oxide, niobium oxide, chromium oxides, scandium, yttrium, lanthanum, thorium, uranium oxides, other rare earth oxides, or a combination thereof).

Embodiments described herein offer a number of key differences and advantages over conventional compositions and related methods of fabrication. In particular, in some embodiments, a CPM described herein may incorporate materials of the type described above as part of its 3D design in the form of particles having sizes greater than 1 micron, e.g., in a powder form.

### Fabrication Methods

In a related aspect, a method for formation of a CPM is disclosed, which comprises forming a macroscopic porous matrix, and incorporating a plurality of preformed FPPs within said macroscopic porous matrix.

In some embodiments, the CPM can be generated by combining preformed FPPs with a precursor of the macroscopic porous structure and optionally binders, dispersants, stabilizers, pore forming agents, surface modifiers, and forming composite porous material via initiation of a chemical and/or a physical process. In some embodiments, the chemical or the physical process is induced by at least one of thermal, photo, electromagnetic, or acoustic energy. In some embodiments, the physical and/or the chemical process can include any of polymerization, cross linkage, condensation and/or sintering.

In some embodiments, the fabrication of a CPM includes generating a formulation including compound FPPs (pores are still filled), an MPS precursor, a plurality of FCs, optionally binders, stabilizers, pore forming agents, surface modifiers, and other additives.

In some embodiments, the formulation can be extruded, casted, and applied onto a substrate in the form of a coating and at least a part of the templating portion of the FFPs can be removed.

The fabrication method can further include post modification of the CPMs.

### BRIEF DESCRIPTION OF THE DRAWINGS

FIG. 1A schematically depicts a CPM according to an embodiment of the present teachings,

FIG. 1B schematically depicts the MPS matrix of the CPM depicted in FIG. 1A,

FIG. 1C schematically depicts the assembly of various components forming the CPM depicted in FIG. 1A,

FIG. 2A schematically depicts a CPM according to another embodiment of the present invention,

FIG. 2B schematically depicts the MPS matrix of the CPM depicted in FIG. 2A,

FIG. 2C schematically depicts the assembly of various components of the CPM depicted in FIG. 2A,

FIG. 3A schematically depicts a CPM according to another embodiment of the present teachings,

FIG. 3B schematically depicts the MPS matrix of the CPM depicted in FIG. 3A,

FIG. 3C schematically depicts the assembly of various components of the CPM depicted in FIG. 3A,

FIGS. 4A and 4B are flow charts depicting various steps in examples of methods for forming a CPM according to some embodiments of the present teachings,

FIG. 5A shows SEM images of porous alumina microparticles (alumina FPPs) exhibiting a non-spherical shape,

FIG. 5B shows SEM images of spherical silica microparticles (silica FPPs),

FIG. 5C shows SEM images of mixed composition—copper/alumina FPPs with a spherical shape,

FIG. 5D shows SEM images of compound alumina/polystyrene microparticles with a spherical shape,

FIG. 5E shows SEM images of Pd/alumina FPPs having a bawl-like shape,

FIG. 5F shows a magnified SEM image of Pd/alumina FPPs shown on FIG. 5E where Pd FCs (indicated with arrows) are distributed on the surface of a porous structure according to an embodiment of the present teachings,

FIGS. 6A and 6B present photographs of a material having a plurality of channels in which at least a portion of some of the channels are coated with a CPM according to some embodiments of the present teachings,

FIG. 6C shows an SEM image the CPM deposited on internal channels of the porous substrate depicted in FIGS. 6A and 6B,

FIG. 6D is a magnified view of an encircled portion of the SEM image depicted in FIG. 6C,

FIG. 7A presents a photograph of a foam-like scaffold coated with a CPM according to an embodiment of the present teachings,

FIG. 7B presents an SEM image of a portion of the coated foam-like scaffold depicted in FIG. 7A,

FIG. 7C is a high magnification SEM image showing the CPM shown in FIG. 7B (the inset shows a magnification of a portion of the SEM image),

FIG. 8A presents light-off conversion curve of cyclohexane to CO₂ by a Pd/Alumina FPPs powder according to an embodiment of the present teachings, and

FIG. 8B presents the light-off curve for the conversion of cyclohexane using a corrugated FrCrAl monolith modified by a CPM incorporating Pd/Alumina FPPs.

### DETAILED DESCRIPTION

The present teachings are generally directed to porous matrices, functional porous particles (FPPs), functional components (FCs), which can be combined in composite porous materials (CPMs), which can be employed in a plurality of different applications. Various terms are used herein according to their ordinary meanings in the art. The term “about” as used herein to modify a numerical value is intended to indicate variation of at most 10 percent around that numerical value. The term “nanoparticle” as used herein refers to particles having a maximum dimensional size (e.g., a diameter or a maximum cross-sectional size) equal to or less than 1 micrometer (micron), e.g., in a range of about 0.5 nm to about 100 nm.

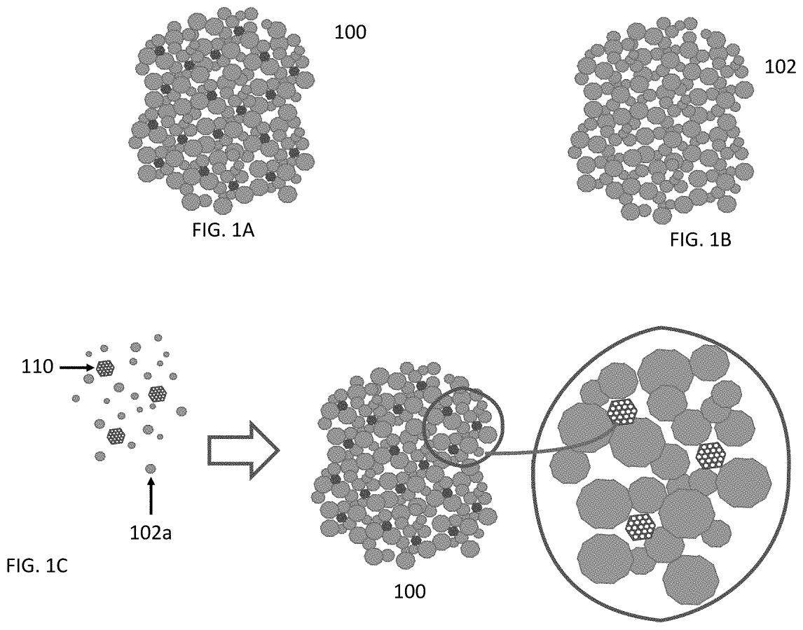

With reference to FIGS. 1A, 1B, and 1C, a CPM 100 according to an embodiment includes an MPS 102 formed by a plurality of discrete components 102a, which are assembled so as to form a porous matrix with pore sizes, e.g., diameters or other cross sections, e.g., in the case of high aspect ratio pores, in a range of about 100 nm to about 5 mm, e.g., in a range of about 400 nm to about 3 mm, or in a range of about 600 nm to about 1 mm, or in a range of about 800 nm to about 0.8 mm, or in a range of about 1000 nm to about 500 microns, or in a range of about 2000 nm to about 200 microns, or in a range of about 2500 nm to 100 micron. In some embodiments, the porosity of the MPS (i.e., the ratio of the volume of the pores relative to the total volume of the MPS) can be, for example, in a range of about 10% to 90%, e.g., in a range of 20% to about 80%, or in a range of about 30% to about 70%, or in a range of about 40% to about 60%, or in the range of about 50% to about 70%.

MPS 102 can be formed of a variety of suitable materials, such as the materials discussed above including various combinations of those materials. A plurality of FPPs 110 can be distributed within the pores of the porous matrix generated via assembly of the discrete components 102a. In some embodiments, the FPPs can have a size, for example, a diameter or another cross-sectional dimension, in a range of about 50 nm to about 2 mm, (e.g., in a range of about 200 nm to about 1 mm, or in a range of about 600 nm to about 0.5 mm), such as in a range of about 1000 nm to about 200 microns (e.g., in a range of about 2000 nm to about 100 microns), or in a range of about 5000 nm to about 50 microns.

In some embodiments, the FPPs 110 are fixedly attached to the porous matrix while in other embodiments, at least a portion of the FPPs 110 can move through some of the pores of the porous matrix without exiting the porous matrix due to physical barriers such as narrow channels (smaller than the FPP size) connecting adjacent pores of the MPS.

The discrete components 102a and the FPPs can be formed, for example, of the materials discussed above. Further, the FPPs can be functionalized with a variety of FCs, such as those discussed above. Some examples of FCs can include, without limitation, metal and/or metal oxide nanoparticles having sizes in the range of about 1 nm to about 20 nm, complex salts with alkali, alkali-earth, and group (III) metals and/or transition metal salts such as salts of nickel, copper, cobalt, manganese, magnesium, chromium, iron, platinum, tungsten, zinc, or other metals. In some embodiments, the FPPs can exhibit a porosity in a range of about 10% to about 90%, for example, in a range of about 28% to about 80%, or in a range of about 30% to about 70%, or in a range of about 30% to about 70%.

In some embodiments, the material(s) from which the MPS 102 is formed can be the same as the material(s) from which the FPPs are formed, but without the FCs that are added to the FPPs for their functionalization. In other embodiments, the MPS 102 and the FPPs can be formed of different materials.

In some embodiments, the FCs include one or more biologically derived materials, such as enzymes and proteins.

While in this embodiment a plurality of FPPs is distributed within one or more pores of the porous matrix generated via assembly of the discrete components 102a, in other embodiments the porous matrix formed, for example, via assembly of the discrete components 102a does not include the FPPs. In other words, in some such embodiments, the present teachings can provide a porous macroscopic structure having a plurality of pores having the sizes described above. For example, in some embodiments, the porous matrix can have pore sizes, e.g., diameters or other cross sections, e.g., in the case of high aspect ratio pores, in a range of about 100 nm to about 5 mm, e.g., in a range of about 400 nm to about 3 mm, or in a range of about 600 nm to about 1 mm, or in a range of about 800 nm to about 0.8 mm, or in a range of about 1000 nm to about 500 microns, or in a range of about 2000 nm to about 200 microns, or in a range of about 2500 nm to 100 micron. In some embodiments, the porosity of the MPS (i.e., the ratio of the volume of the pores relative to the total volume of the MPS) can be, for example, in a range of about 10% to 90%, e.g., in a range of 20% to about 80%, or in a range of about 30% to about 70%, or in a range of about 40% to about 60%, or in the range of about 50% to about 70%. Further, while in some embodiments such a porous matrix can be formed as an assemblage of a plurality of discrete components in other embodiments, the porous matrix can be formed as an integral unit, e.g., via fusing the discrete components together. Such a macroscopic porous structure can be employed in a variety of different applications, e.g., without limitation, gas or liquid phase purification, sorption, separation, energy conversion and storage, catalysis, sensing, electronics, drug delivery, tissue engineering, construction, and additive manufacturing.

In some embodiments in which CPMs according to the present teachings are employed for catalysis, the catalytic function can be achieved, for example, via heating the CPMs to elevated temperatures, for example, to a temperature in a range of about 50° C. to about 1500° C., e.g., 100° C., 150° C., 200° C., or 500° C.

As noted above, in some embodiments, a CPM according to the present teachings can be used to at least partially coat the inner surfaces of one or more pores of a porous structure. In some such embodiments, the coating as well as the coated porous structure can be considered as a CPM as disclosed herein. In other words, in some embodiments, a material structure according to the present teachings can include a hierarchy of CPMs, e.g., where a CPM can incorporate one or more other CPMs.

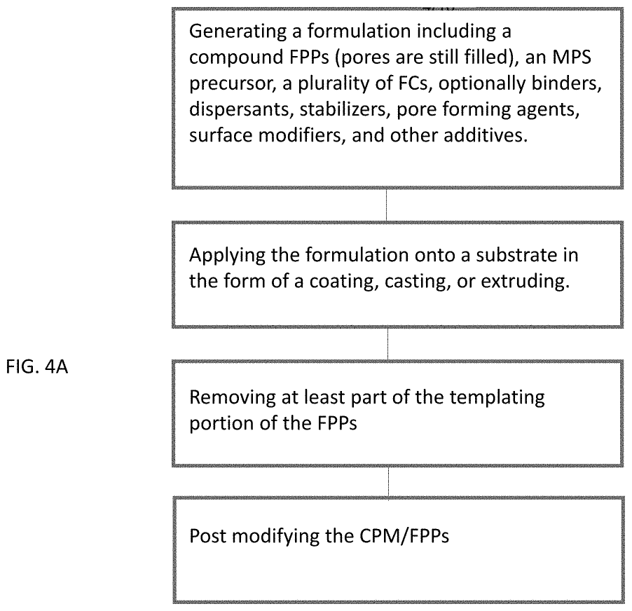

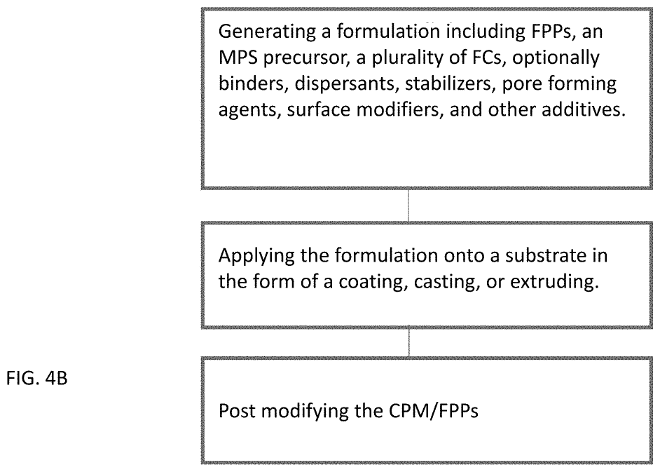

Referring again to FIGS. 1A, 1B, and 1C as well as the flow charts of FIG. 4A and 4B, one method for fabrication of the CPM 100 includes generating a formulation including compound FPPs (pores are still filled), an MPS precursor, a plurality of FCs, optionally binders, dispersants, stabilizers, pore forming agents, surface modifiers, and other additives. The formulation can be extruded, casted, sprayed, and applied onto a substrate in the form of a coating and at least a part of the templating portion of the FPPs can be removed. The fabrication method can further include post modifying the CPMs.

An example of post modification of the CPMs include, without limitation, thermal treatment, irradiation, deposition of catalytic nanoparticles, impregnation with various salts, binding of enzymes, surface functionalization with a function providing improved dispersibility, stimuli-responsive molecules (e.g., oligonucleotides, and hydrogels), and functions to adjust surface hydrophobicity. An example includes hydroxylation of surface, silanization of surface using organosilanes (e.g., octadecylotrichlorosilane, fluoroalkyl silane, aminopropyltriethoxy silane, aminopropyltrimethoxy silane) and modification with thiol derivatives. The post modification can be performed homogeneously throughout the exposed surfaces or predominantly at specific locations.

Another example includes generating a formulation including FPPs from which at least part of the templating material was removed, an MPS precursor, a plurality of FCs, optionally binders, dispersants, stabilizers, pore forming agents, surface modifiers, and other additives and applying the formulation onto a substrate in the form of a coating, casting, or an extruded layer. The final steps of fabrication may include post modification of the CPMs.

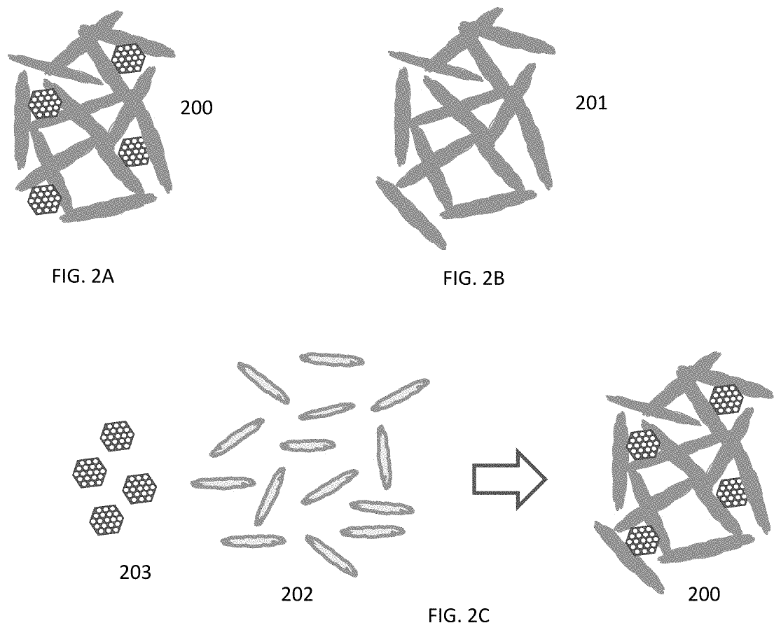

With reference to FIGS. 2A, 2B, and 2C, a CPM material 200 according to another embodiment includes an MPS 201 formed as an arrangement of a plurality of elongated elements 202 that are assembled relative to one another so as to form a porous structure. Similar to the porous material 100, a plurality of FPPs 203 are distributed within the pores of the MPS 201. The FPPs 203 are similar to the FPPs 110. Similar to the FPPs 110, the porous particles 203 can be functionalized, e.g., in a manner discussed above. Some examples of functional components can include, without limitation, precious metals, non-precious metals, and metal oxide nanoparticles, complex salts with alkali, alkali-earth, and group (III) metals and/or transition metal salts.

A fabrication method similar to that described above in connection with the CPM 100 can be employed to fabricate the CPM material 200.

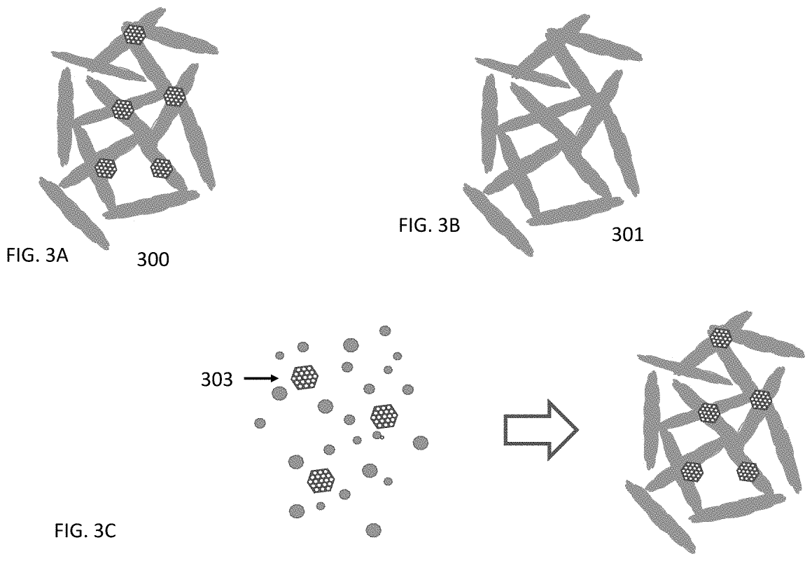

As noted above, in some embodiments, the FPPs can be at least partially embedded in the structural elements of the porous matrix (MPS). With reference to FIGS. 3A, 3B, and 3C, a CPM 300 according to such an embodiment can include a plurality of elements 301 that are formed in the presence and around a plurality of FPPs to form a CPM 300. A plurality of FPPs 303 are partially or wholly embedded in at least some of the elements 301.

Further, in some embodiments, some of the FPPs can be distributed within the pores of the porous matrix and some of the FPPs can be embedded within the structural elements of the matrix, for example, as shown in FIG. 3C.

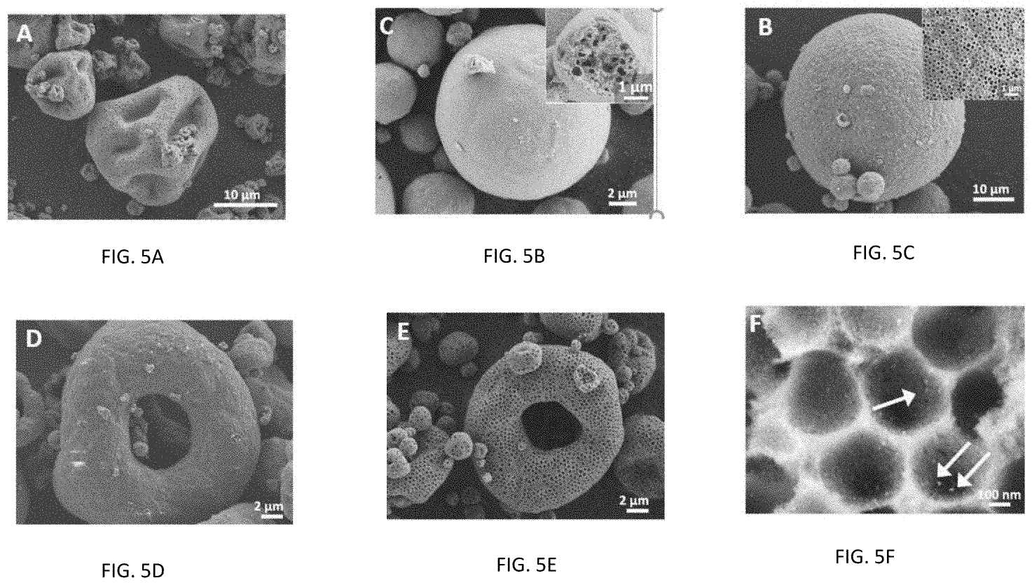

As noted above, a variety of FPPs formed of a variety of different materials and having a variety of different shapes can be used in the practice of the present teachings. By way of example, FIGS. 5A, 5B, 5C, 5D, and 5E show Scanning Electron Microscopy (SEM) images of some examples of FPPs that can be employed. Specifically, FIG. 5A shows porous alumina microparticles exhibiting a deflated ball shape. FIG. 5B shows porous spherical silica microparticles, FIG. 5C shows spherical microparticles formed as a mixed copper/alumina oxide composition exhibiting internal porous structure (inset), FIG. 5D shows compound FPPs formed of alumina matrix and spherical polystyrene templating colloids; FIG. 5E shows porous alumina microparticles having a bowl-like shape, and FIG. 5F shows Pd functional nanoparticles (FCs, indicated with arrows) that are distributed on the surface of a porous structure according to an embodiment of the present teachings.

The FPPs shown in FIGS. 5A, 5B, 5C and 5E were synthesized using spray drying. The FPPs employed in the practice of the present teachings can have a variety of shapes and are generally formed as high surface area porous materials with an interconnected network of pores. Some shapes can have especially advantageous properties for specific applications. For example, FPPs with a spherical, toroid-like, bowl-like, or punctured/deformed sphere morphology, e.g., as shown in FIG. 5E, can enable improved diffusion and mass transport properties in catalytic applications.

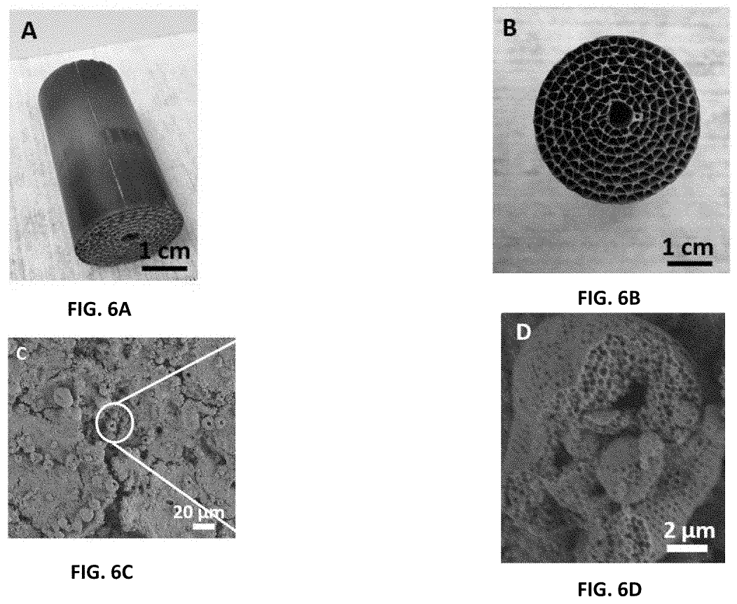

FIGS. 6A, 6B, and 6C show examples of CPM-modified internal channels of a FeCrAl monolith and FeCrAl foam, respectively, with a CPM including Pd/Alumina FPPs shown in FIG. 5E. More specifically, FIGS. 6A and 6B show the top view (FIG. 6A) and side view (FIG. 6B) photographic images of FeCrAl monolith substrate. FIG. 6C shows an SEM image of the CPM deposited on internal channels of the monolith. FIG. 6D presents a zoomed-in image of an FPP similar to the encircled portion in FIG. 6C.

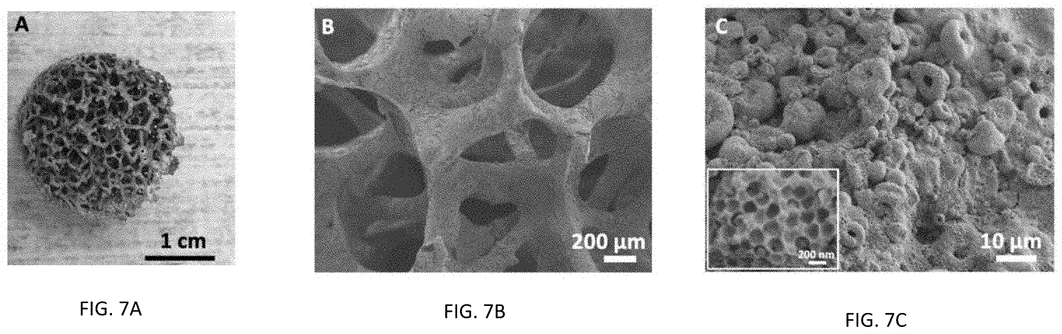

FIG. 7A presents a photograph of a foam-like scaffold coated with a CPM according to an embodiment of the present teachings, where the scaffold is formed of FeCrAl alloy and the CPM coating includes Pd/Alumina FPPs. FIG. 7B presents an SEM image of a portion of the coated foam-like scaffold depicted in FIG. 7A. And FIG. 7C is a high magnification SEM image showing the CPM depicted in FIG. 7B (the inset shows a magnification of a portion of the SEM image)

The structures shown in FIGS. 6A, 6B, and 6C, as well as FIGS. 7A, 7B, and 7C are examples of material structures that can be viewed as being formed as a plurality of hierarchical CPMs. For example, the coating provided on the surfaces of the internal pores can be viewed as a CPM. Further, the entire material structure can also be viewed as a CPM.

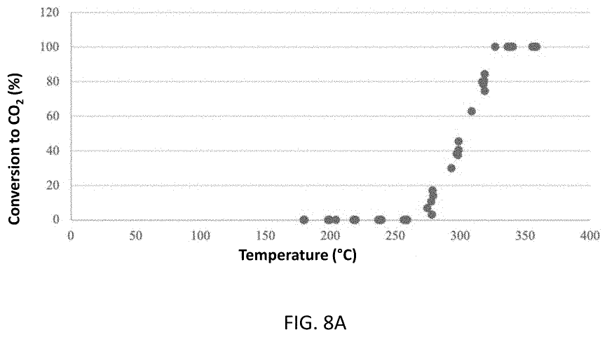

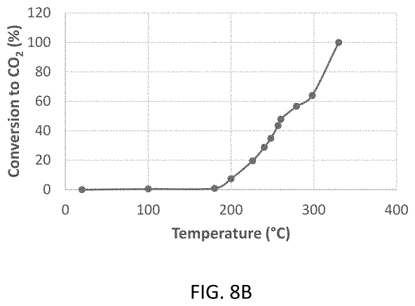

By way of further illustration, FIGS. 8A and 8B present light-off curves (concentration as a function of the reaction temperature) for the conversion of cyclohexane to carbon dioxide using Pd/Alumina FPPs (i.e., alumina FPPs with Pd nanoparticles as FCs, shown in FIG. 5E) in a form of a powder subjected to a stream of 0.6 L/min cyclohexane (FIG. 8A) and as a part of a CPM on a FeCrAl monolith subjected to 5 L/min cyclohexane stream (FIG. 8B), according to some embodiments of the present teachings.

The porous materials according to the present teachings can find a variety of different applications. Some examples of such applications include, without limitation, gas or liquid phase purification, sorption, separation, energy conversion and storage, catalysis, sensing, electronics, drug delivery, tissue engineering, construction, and additive manufacturing.

Example of an Experimental Procedure for the Synthesis of FPPs

The FPPs discussed above in connection with FIGS. 5A-E were fabricated using a spray drying method. Dispersions of polystyrene templating colloids and matrix precursors were atomized using a spray nozzle. The inlet temperature for various experiments was kept in the range of 100-190° C. The obtained microparticles were heat treated at 500-800° C. to remove templating colloids to form FPPs. Compound alumina microparticles (FIG. 5D) and alumina FPPs (FIG. 5A) were synthesized using aqueous dispersions of polystyrene colloids with alumina precursor (˜3 wt. %). Silica FPPs (FIG. 5B) and mixed Cu/alumina FPPs (FIG. 5C) were synthesized in a similar manner using a dispersion of silica nanoparticles and a mixture of alumina precursor and copper (II) nitrate accordingly. Alumina FPPs decorated with Pd FCs (FIG. 5E) were obtained using Pd modified polystyrene colloids as a templating material.

### Coating of FeCrAl Monoliths and Foams by CPM

Commercially available FeCrAl corrugated monoliths with parallel channels and FeCrAl foams were used as substrates for the deposition of a CPM including Pd/alumina FPPs on their internal channels. The samples (˜2 inch length and 1 inch in diameter) were first cleaned by sonication in acetone to remove soluble impurities and any dust produced during manufacturing processes. Cleaned and dried samples were submerged in a slurry containing aqueous Pd/a lumina FPPs (˜15 wt.%) for ˜1 min, then the excess slurry was removed via air blowing through the channels. The samples were then dried followed by heat treatment at 500° C. for 2 h.

Those having ordinary skill in the art will appreciate that various changes can be made to the above embodiments without departing from the scope of the invention.

What is claimed is:

1. A composition, comprising:
a macroscopic porous structure including a plurality of pores, and
a plurality of functional particles coupled to said macroscopic porous structure,
wherein said functional particles comprise porous particles.

2. The composition of claim 1, wherein said pores of said macroscopic porous structure have pore sizes in a range of about 100 nm to about 5 mm.

3. The composition of claim 1, wherein each of said functional porous particles comprises a plurality of pores with sizes in a range of about 0.5 nm to about 100 microns.

4. The composition of claim 3, wherein said functional porous particles have a size in a range of about 50 nm to about 2 mm.

5. The composition of claim 1, wherein said functional porous particles are distributed within at least a portion of the pores of the macroscopic porous structure.

6. The composition of claim 5, wherein at least one of said pores of the macroscopic porous structure comprises a plurality of functional porous particles.

7. The composition of claim 1, wherein at least a portion of said functional porous particles are at least partially embedded in one or more structural elements of said macroscopic porous structure.

8. The composition of claim 1, further comprising at least one functional component coupled to at least one of said functional porous particles.

9. The composition of claim 8, wherein said at least one functional component is deposited on an inner surface of a wall of a pore of said at least one of said functional porous particles.

10. The composition of claim 8, wherein said at least one functional component is embedded at least partially within a wall of a pore of said at least one of said functional porous particles.

11. The composition of claim 8, wherein said functional components have a size in a range of about atom size to about 500 nm.

12. The composition of claim 8, wherein said at least one functional component comprises a metallic particle.

13. The composition of claim 1, wherein said macroscopic porous structure comprises a plurality of discrete structures assembled relative to one another to form said macroscopic porous structure.

14. The composition of claim 1, wherein said macroscopic porous structure comprises a single unitary structure.

15. The composition of claim 1, wherein said macroscopic porous structure comprises a material of natural origin.

16. The composition of claim 15, wherein said material of natural origin comprises any of a protein- or polysaccharide-based material, silk fibroin, chitin, shellac, cellulose, hemp, chitosan, alginate, gelatin, or a mixture thereof.

17. The composition of claim 1, wherein said macroscopic porous structure comprises an inorganic material.

18. The composition of claim 17, wherein said inorganic material comprises any of silica, alumina, titania, ceria, zirconia, vanadia, yttria, neodia, hafnia, and combinations thereof.

19. The composition of claim 1, wherein said macroscopic porous structure comprises a polymeric material.

20. The composition of claim 19, wherein said polymeric material comprises any of polyurethane, polystyrene, poly(methyl methacrylate), polyacrylate, poly(alkyl acrylate), substituted polyalkylacrylate, polystyrene, poly(divinylbenzene), polyvinylpyrrolidone, poly(vinylalcohol), polyacrylamide, poly(ethylene oxide), polyvinyl chloride, polyvinylidene fluoride, polytetrafluoroethylene, other halogenated polymers, hydrogels, organogels, and combinations thereof.

21. The composition of claim 1, wherein said functional porous particles comprise any of metallic, inorganic, organic, and biological materials or combinations thereof.

22. The composition of claim 21, further comprising at least one functional component coupled to at least one of said functional porous particles.

23. The composition of claim 22, wherein said at least one functional component comprises any of a metal, a metal oxide, a polymer, a natural or a biological material.

24. The composition of claim 1, wherein said macroscopic porous structure exhibits a porosity in a range of about 10% to about 90%.

25. The composition of claim 1, wherein said macroscopic porous structure comprises any of a metal, a metal alloy or a combination thereof.

26. The composition of claim 25, wherein said metal comprises any of copper, nickel, cobalt, gold, silver, titanium, tungsten, aluminum, palladium, platinum.

27. The composition of claim 25, wherein said metal alloy comprises any of stainless steel, brass, FeCrAl (iron-chromium-aluminum alloy), ferritic steel, austenitic steel (a chromium-nickel alloy).
